(19) United States
(12) Patent Application Publication
(10) Pub. No.: US 2023/0192005 A1
(43) Pub. Date: Jun. 22, 2023

(54) HITCH MOUNTED CARRYING AND ROOF RACK LOADING APPARATUS FOR A VEHICLE

(71) Applicant: Matthew John Olsen, Fergus Falls, MN (US)

(72) Inventor: Matthew John Olsen, Fergus Falls, MN (US)

(21) Appl. No.: 17/557,037

(22) Filed: Dec. 20, 2021

(51) Int. Cl. B60R 9/06; B60R 9/042; B60R 9/045; B60D 1/02

(52) U.S. Cl. CPC B60R 9/06; B60R 9/042; B60R 9/045; B60D 1/02; B60R 2011/004

(57) ABSTRACT

The present invention provides apparatus, devices, methods, and configurations to carry and assist the loading and unloading of heavy loads or loads having irregular or elongated shapes such as ladders, lumber, personal recreation equipment including but not limited to surfboards, paddleboards, canoes, kayaks, skis, snowboards, bicycles, and other items to reduce effort and impediments to loading a vehicle's roof rack and to allow full utilization of the vehicle's receiver. The device can pivot into either the loading and unloading position or the transport position when a pin is removed from the device at a pivot point in its vertical member. The device is mounted to a hitch receiver extension which is secured to the vehicle's hitch receiver. The hitch receiver extension allows the vehicle to transport another apparatus such as a trailer or bike rack mounted to the hitch receiver extension.

### FIELD OF THE INVENTION

The present invention generally relates to a hitch mounted carrying device and a roof rack loading and carrying device for a vehicle.

### BACKGROUND OF THE INVENTION

Many people use their vehicles to travel for work or recreation due to its convenience and ability to carry, haul and transport items from one location to another. Modern vehicles are often equipped with roof racks and hitch receivers for transporting large, lengthy, and heavy loads or such racks or receivers can be added as desired.

Sport Utility Vehicles (SUV's), vans and trucks are particularly useful and common. These vehicles, however, are often quite tall making it difficult to load and unload recreational equipment, materials and other items onto or off of the roof. The conveniences of roof racks are offset by the difficulty of loading them.

In U.S. Pat. No. 5,775,560, Zahn et al, describe a carrier apparatus that attaches to a vehicle hitch receiver. The carrier apparatus is able to pivot into either the vertical or horizontal positions in order to carry a number of accessories so that items need not be loaded on the roof.

In U.S. Pat. No. 5,884,824, Spring, Jr. describes an equipment roof rack that mounts to the roof of a vehicle. The roof rack is made up of a movable carriage assembly such that the rack can be extended out and downwards over the side of the vehicle for convenient loading and unloading and then positioned back on top of the vehicle for transportation.

U.S. Pat. No. 8,028,874 describes a system for loading kayaks onto a vehicle roof. The apparatus is mounted on a vehicle hitch and has an adjustable height roller assembly such that a kayak can be positioned on the rollers and pushed on the roof of a vehicle.

AU 2012100198 describes an elongated load supporting structure for a vehicle. The structure is mounted to a ball-point hitch and can pivot between vertical and angled positions. The structure allows an elongated load to be pushed on the roof of a vehicle while pivoting from the angled to the vertical position.

In U.S. Pat. No. 8,590,758, Gray describes a rack system for transporting personal watercrafts on a Recreational Vehicle (RV). The rack system attaches to the RV's receiver hitch and transports the personal watercrafts vertically behind the RV.

In U.S. Pat. No. 9,067,522, Laverack et al, describe a kayak transport device that is attached to the roof of a vehicle. The device contains a rack assembly that can be rotated down to the side of the vehicle for loading and then locked back on top of the vehicle for transportation.

U.S. Pat. No. 9,156,392 describes an apparatus for extending a vehicle's cargo capacity. The apparatus attaches to the vehicle's hitch receiver and can be setup in horizontal, vertical, diagonal and angular positions to accommodate a variety of vehicle designs and cargo shapes.

U.S. Pat. No. 9,346,411 describes an apparatus that attaches to a vehicle's hitch receiver and extends vertically to support an independent platform to transport cargo at the height of the vehicle's roof rack or lower, if adjusted.

Though some devices provide adequate means for transporting oversized equipment and cargo loads either on a vehicle's roof rack or hitch transport device, they fail to simplify and improve the ability to load and unload such equipment and cargo loads. Heavy loads or loads having irregular or elongated shapes such as ladders, lumber, personal recreation equipment (e.g. surfboards, paddleboards, canoes, kayaks, skis, snowboards, bicycles, etc), and other equipment are particularly difficult to load and position on to tall vehicles, especially by an individual. In fact, loading and unloading onto a tall vehicle, more than posing a challenge can in fact be dangerous since the individual may need to climb on the side of the vehicle and use the stools, ladders, running boards, vehicle frame, or tires, which may be slippery or not conducive to the footing necessary for safe and proper loading. Furthermore, it is time consuming to load and unload these items since one must check all sides of the vehicle in order to position and secure the load. In addition to the difficulty of lifting the object being hauled and reaching the height of the roof rack, securing the object being hauled is complicated by lack of leverage, reach, or visual confirmation of the object being secured while working above the vehicle and with poor footing.

Another problem with hitch transportation devices is that the apparatus itself uses up the hitch receiver making it inaccessible for other applications such as towing. Functionally, any transportation device that engages with the hitch receiver prevents that same hitch receiver from being used for a second purpose. Therefore, it is impossible to take advantage of the vehicle's entire hauling capabilities.

What is needed in the art is a roof rack loading device that overcomes the difficulties associated with loading and unloading heavy, irregular or elongated loads. The device should simplify the method of loading and unloading such that an individual without much strength or height can accomplish the task. The device should streamline the loading and unloading process to minimize the time expended. The device should be safely operated from the ground to prevent injury and accident. The device should allow the load to be secured before being raised to the roof rack where fastening is complicated and unsafe. The device should be intuitive and simple to operate. Furthermore, the device should maintain access to the hitch receiver allowing additional transportation assemblies or trailers to be transported in order to maximize the hauling capacity of the vehicle. A novel hitch mounted roof rack apparatus and method of use overcomes the disadvantages and challenges associated with current roof rack and hitch receiver carrying devices.

### SUMMARY OF THE INVENTION

The present invention addresses the aforementioned needs in the art, as will now be summarized and then further described in detail below. The present invention relates to a transport rack that consists of a rack assembly, mounted on a pivoting vertical member that is adjustable in height capable of aligning with the roof racks of a vehicle and which attaches to a vehicle using a hitch receiver extension. Each component provides unique advantages over the prior art. First, the rack assembly allows equipment to be attached quickly and securely by horizontal cross bars parallel to the width of a vehicle and vertical attachment bars on each side. Additional accessories or configurations may be attached to the rack assembly for varying loads. Second, by removing a pin, the vertical support member can rotate approximately 90 degrees around a stationary pin since the pivot is located near the center of the vertical height of the vehicle. The back of the rack assembly is then able to be lowered to rest on the ground. This allows loads or equipment to be secured to the rack assembly from the ground level. This avoids lifting large or heavy loads overhead. Because the loads can be secured to the rack while it is still resting on the ground, the difficulty of securing loads to the roof racks is eliminated. Once secure, the load can then be raised to rest on a vehicle's roof racks. Third, the height of the vertical member is adjustable. This allows the rack assembly to be positioned to match the varying heights of vehicle's or roof racks. By lowering the height of the rack assembly, it could also match the height of a pick-up bed. If loads or equipment are short enough to be hauled within the dimensions of the rack assembly or its attachments, lowering the height of the rack would also allow the load to occupy the airspace above a trailer tongue so as to be protected from winds and improve fuel economy while not interfering with the trailer when turning corners. Fourth, the device attaches to a vehicle by a mount or sleeve that fits around the top and sides of a hitch receiver extension. The mount has a hole that aligns with the hole used for a pin that would secure a hitch such as a ball mount. The pin can be used to secure the present invention to the hitch extension with or without a hitch inserted. By using a hitch receiver that is rated for the appropriate weight capacity, a hitch can be used to haul a boat, camper, trailer or other device that would normally be able to be attached to the vehicle by utilizing its hitch receiver.

### BRIEF DESCRIPTION OF THE DRAWINGS

The advantages of the present invention will be better understood by referring to the descriptions below with the accompanying drawings. The drawings are not to scale and represent exemplary configurations that depict general application of the invention.

FIG. 1 illustrates a side perspective of the hitch mounted carrying and roof rack loading device and its major components according to the present invention.

FIG. 2 illustrates a side perspective of the hitch mounted carrying and roof rack loading device in the loading position resting on the ground. The device is attached to a vehicle's hitch receiver and an elongated load has been secured to it.

FIG. 3 illustrates a side perspective of the hitch mounted carrying and roof rack loading device in the transport position. The device is attached to a vehicle's hitch receiver and an elongated load has been loaded to the vehicle's roof rack.

### DETAILED DESCRIPTION OF EMBODIMENTS OF THE INVENTION

The apparatus, systems, and methods of the present invention will now be described in detail by reference to various non-limiting embodiments, including the figures which are exemplary only. The details of the present invention are listed as exemplary embodiments and should be understood to be nonlimiting of the various forms in which the features may be embodied. The description of the present invention refers to exemplary embodiments to explain the features which may be expressed in other forms.

Unless otherwise indicated, all numbers expressing dimensions, capacities, and so forth used in the specification and claims are to be understood as being modified in all instances by the term “about.” Without limiting the application of the doctrine of equivalents to the scope of the claims, each numerical parameter should at least be construed in light of the number of reported significant digits and by applying ordinary rounding techniques.

The present invention may be practiced by implementing method steps in different orders than as specifically set forth herein. All references to a “step” may include multiple steps (or substeps) within the meaning of a step. Likewise, all references to “steps” in plural form may also be construed as a single process step or various combinations of steps.

As used in this specification and the appended claims, the singular forms “a,” “an,” and “the” include plural referents unless the context clearly indicates otherwise.

The transitional phrases “comprising,” “consisting essentially of” and “consisting of” define the scope of a claim with respect to what unrecited additional components or steps, if any, are excluded from the scope of the claim. The transitional term “comprising,” which is synonymous with “including” or “containing” is inclusive or open-ended and does not exclude additional, unrecited elements or method steps. The transitional phrase “consisting essentially of” limits the scope of a claim to the specified materials or steps and those that do not materially affect the basic and novel characteristic(s) of the claimed invention.

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures and components have not been described in detail so as not to obscure the related relevant function being described. Also, the description is not to be considered as limiting the scope of implementation described herein.

One embodiment of the present invention consists of a roof rack loading device having a loading or unloading position and a transport position. A method for using the roof rack loading device is also included.

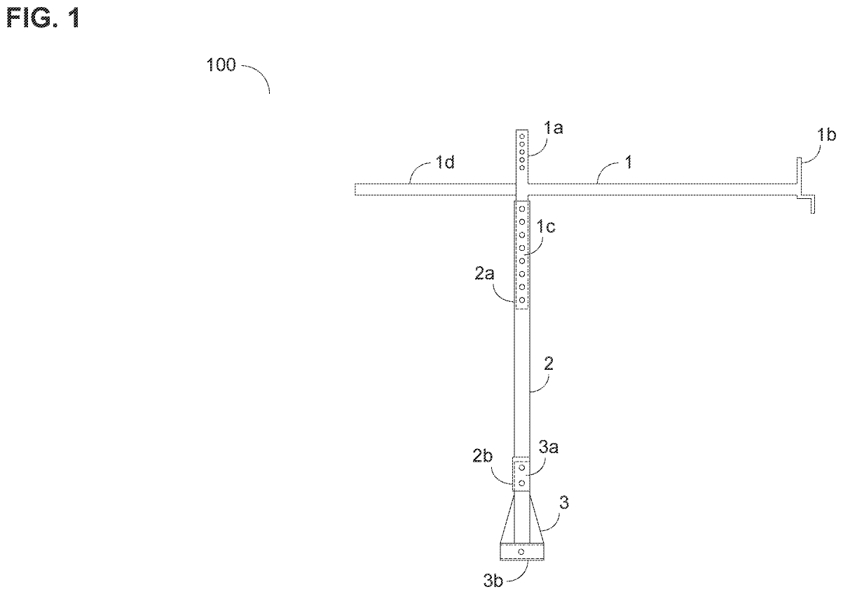

FIG. 1 illustrates one embodiment of a hitch mounted carrying and roof rack loading device 100. The device 100 is shown from the side perspective and comprises an upper rack assembly 1, a support arm 2, a mounting channel 3 and a hitch receiver extension 4. The device 100 can be made of metal, plastic or wood. In a preferred embodiment, the device 100 is constructed out of a strong, lightweight material such as aluminum. In another embodiment, the device 100 is constructed from different materials. In one embodiment, the upper rack assembly 1, support arm 2, mounting channel 3 and hitch receiver extension 4 are all made from different materials. Alternatively, the upper rack assembly 1 and support arm 2 are constructed from the same material while the mounting channel 3 and hitch receiver extension 4 are constructed from a different material.

The upper rack assembly 1 contains a number of elements that allow a variety of loads to be secured and transported. In one embodiment, the load is secured to the upper rack assembly 1. The upper rack assembly 1 may include one or more cross members with one or more arms 1a to secure a load. In a preferred embodiment, the upper rack assembly 1 includes two adjustable cross members each with two arms 1a that are positioned on each side of the load. The arms 1a may include one or more holes through which a pin, strap, cord or rope may be fastened in order to secure a load or to allow dimensions to be adjustable. In one embodiment, a pin or other mechanism can be inserted through the holes in the arms 1a to function as a hinge for a strap or closure used to secure the load to the upper rack assembly. In one embodiment, the arms 1a may include one or more holes to accommodate loads of varying thickness or widths. The cross members of the upper rack assembly 1 may also be adjustable by one or more holes through which a pin could allow the cross members to accommodate loads of varying widths.

The base 1b part of the upper rack assembly 1 may take on a variety of different forms. The base 1b may include a strap-like device in order to affix a load. In one embodiment, the base 1b is shaped like a box or bowl in which a load can be placed. In another embodiment, the base 1b is a plate against which a load can rest. The base 1b may help prevent the load from falling off the device 100 and vehicle roof rack during transport. In a preferred embodiment, the base 1b can be rested on the ground when a load is being secured to the upper rack assembly 1.

The upper rack assembly 1 is also equipped with a positioning arm 1c that mates with the positioning section 2a of the support arm 2. In a preferred embodiment, the positioning arm 1c is inserted into the positioning section 2a of the support arm 2. The positioning arm 1c is equipped with two or more holes through which a pin can be inserted. Similarly, the positioning section 2a of the support arm 2 is equipped with one or more holes through which a pin can be inserted. The positioning arm 1c allows the entire upper rack assembly 1 to be raised out of or lowered into the positioning section 2a of the support arm 2. Such positioning allows the height of the upper rack assembly to match the height of the vehicle, or various heights such as a truck bed or rear window. In one embodiment, a pin is inserted through positioning section 2a and positioning arm 1c in order to support and maintain a specific position of the upper rack assembly 1. In one embodiment the positioning arm 1c is raised to a position such that the upper rack assembly 1 is directly in line with a vehicle's roof rack. When the upper rack assembly 1 is in line with a vehicle's roof rack the load can be supported by both the device 100 and the roof rack. Furthermore, in a preferred embodiment, the upper rack assembly 100 is raised or lowered out of the positioning section 2a of the support arm 2 such that it will not interfere with or damage the vehicle.

Optionally, the upper rack assembly 1 is equipped with an extension 1d. The extension 1d allows for particularly long or heavy loads to be loaded and carried on a vehicle's roof rack. In one embodiment the extension 1d can be easily added or removed from the upper rack assembly 1 depending on the load being carried. In another embodiment, there is no need for an extension 1d since the upper roof rack assembly 1 adequately supports the load.

The support arm 2 connects with the mounting channel 3 at a pivot point. The support arm 2 also includes another element that allows the device 100 to safely assist loading and unloading various items onto a vehicle's roof rack. The support arm pivot 2b includes two or more holes that match up with the mounting channel pivot 3a such that a pin can penetrate through each hole. In a preferred embodiment, there are two or more pins that match up with each hole in the support arm pivot 2b and the mounting channel pivot 3a. In a preferred embodiment, the support arm pivot 2b surrounds the mounting channel pivot 3a on two or three sides. The fourth side is left open so that the support arm 2 and the upper rack assembly 1 can pivot around the uppermost hole in the support arm pivot 2b and the mounting channel pivot 3a without interfering with the mounting channel 3.

In a preferred embodiment, the vertical support arm pivot 2b is located approximately in the center of the vertical height of the vehicle to allow the rack assembly to pivot approximately 90 degrees. In another embodiment, the vertical support arm pivot 2b is located at the bottom or top of the vertical support member 2. The two or more holes in the support arm pivot 2b and the mounting channel pivot 3a allow the device 100 to be located in two positions, one for loading and unloading and another for transporting. In a preferred embodiment the upper most pin is securely fastened in place to prevent accidental removal and possible injury. However, in a preferred embodiment, the lower most pin is able to be removed from the support arm pivot 2b and the mounting channel pivot 3a. When the lower most pin is removed, the upper rack assembly 1 and the support arm 2 can pivot around the upper most pin which is inserted in the upper most hole in the support arm pivot 2b and the mounting channel pivot 3a. In another embodiment, the lower most hole remains pinned while the upper most hole retains a removable pin. In a preferred embodiment, the upper rack assembly 1 and the support arm 2 can rotate around the pivot point between 45 and 130 degrees.

The device 100 can be moved into the loading and unloading position by removing the lower most pin and pivoting the upper rack assembly 1 and the support arm 2 around the upper most pin in the support arm pivot 2b and the mounting channel pivot 3a until the upper rack assembly 1 is resting on the ground at the base 1b. In another embodiment, the device 100 can be moved into the loading and unloading position by removing the lower most pin.

From the loading and unloading position, the device 100 can be moved into the transport position. While the lower most pin is removed from the support arm pivot 2b and the mounting channel pivot 3a, the upper rack assembly 1 and the support arm 2 can be pivoted around the upper most pin in the support arm pivot 2b and the mounting channel pivot 3a such that the upper rack assembly 1 is parallel with the ground and the support arm 2 is vertical or perpendicular with the ground. At this point, the lower most pin can again be inserted into the lower most hole of the support arm pivot 2b and the mounting channel pivot 3a. Once the lower most pin is securely fastened and in place the device is safely in the transport position.

In one embodiment, a spring or cylinder is attached to the vertical support member 2 and the mounting channel 3 to assist with positioning the upper rack assembly 1 into either the load and unload position or the transport position. The spring or cylinder may consist of a gas, pneumatic, hydraulic, mechanical or other type that may be used to assist with positioning the upper rack assembly into position.

Therefore, by simply removing the lower most pin from the support arm pivot 2b and the mounting channel pivot 3a, the device 100 can moved into either the loading and unloading position or the transport position.

The mounting channel 3 is used to securely attach the device 100 to a hitch receiver extension 4 and subsequently to a vehicle's hitch receiver. In a preferred embodiment the channel 3b section of the mounting channel 3 is slid over top of a hitch receiver extension 4. In a preferred embodiment, the mounting channel 3 contains holes that align with the standard holes of a hitch receiver extension 4 and is secured to the hitch receiver extension 4 by the pin that also secures the hitch to the hitch receiver extension 4. In an alternative embodiment, the hitch receiver extension 4 has an additional hole located along the extension through which a pin or bolt may be inserted. Once the channel 3b is positioned on the hitch receiver extension 4 they are fastened together using a pin or bolt inserted through the channel 3 hole and the additional hole located along the hitch receiver extension 4. The hitch receiver extension 4 may be any length. In one embodiment, the hitch receiver extension 4 is as short as possible to reduce the weight of the device 100. In another embodiment, the hitch receiver extension 4 is long enough to allow a vehicle's tailgate, rear window or rear door to open without interfering with the device 100. In one embodiment, the hitch receiver extension 4 allows a second assembly to be connected to the vehicle in addition to the device 100. The second assembly may attach to the hitch receiver extension 4 using normal mounting techniques known by one skilled in the art. In one embodiment, a trailer is attached to the hitch receiver extension 4 using a ball mount hitch. In another embodiment, a bike rack is attached to the hitch receiver extension 4. Thus, both the device 100 and a second assembly can be carried and transported by a vehicle taking advantage of its hauling capacity.

In one embodiment, the mounting channel 3 is secured to the hitch receiver extension 4 while also being connected to the support arm 2 and upper rack assembly 1. In another embodiment, the mounting channel 3 is secured to the hitch receiver extension 4 but is disconnected from the support arm 2 and upper rack assembly 1. In one embodiment, the mounting channel 3 may be secured to the hitch receiver extension 4 while the hitch receiver extension 4 is fastened to a vehicle's hitch receiver. In another embodiment, the mounting channel 3 may be secured to the hitch receiver extension 4 while the hitch receiver extension 4 has not yet been fastened to a vehicle's hitch receiver. Therefore, the device 100 or the mounting channel 3 can be mounted to a hitch receiver extension 4 which may or may not be mounted to a vehicle's hitch receiver. In one embodiment, the device 100 or the mounting channel 3 is stabilized by supporting members that attach to the vehicle's hitch receiver outside of the receiver extension. In one embodiment the device 100 or mounting channel 3 is stabilized by additional members connected to a vehicle's hitch receiver including the safety chain loop or the vehicles frame.

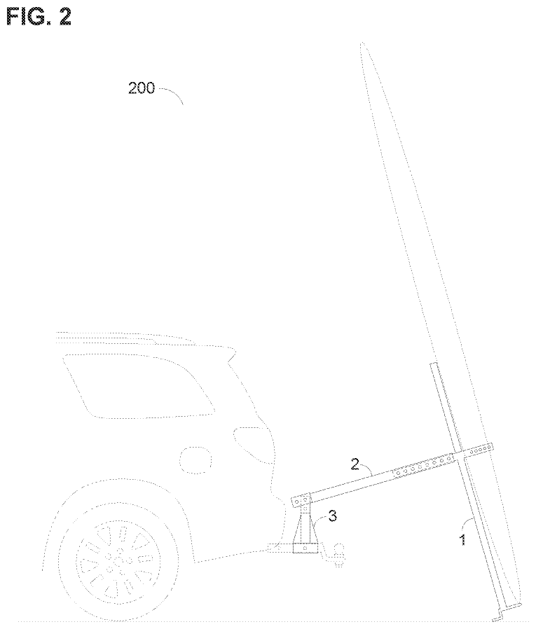

With reference to FIG. 2, the device 200 is stationed in the loading and unloading position and has been secured to a vehicle's hitch receiver by fastening the mounting channel 3 to a hitch receiver extension 4. The hitch receiver extension 4 allows another assembly to be attached to the vehicle, such as a trailer. The device 200 may be secured to various vehicle types including but not limited to a sedan, minivan, cargo van, pickup truck, sport utility vehicle, recreational vehicle or other vehicle.

When the device 200 is in the loading and unloading position, the upper rack assembly 1 is fully resting on the ground. In the loading and unloading position, one can easily position and secure heavy loads or loads having irregular or elongated shapes such as ladders, lumber, personal recreation equipment (e.g. surfboards, paddleboards, canoes, kayaks, skis, snowboards, bicycles, etc.), and other equipment on to the upper rack assembly 1. As shown in FIG. 2, the load is fully resting on the upper rack assembly 1 allowing the user to secure the load without having to climb on top of the vehicle running boards, bumper or roof. This provides a safe method for securing a load to the device 200 which can subsequently be positioned into the transport position.

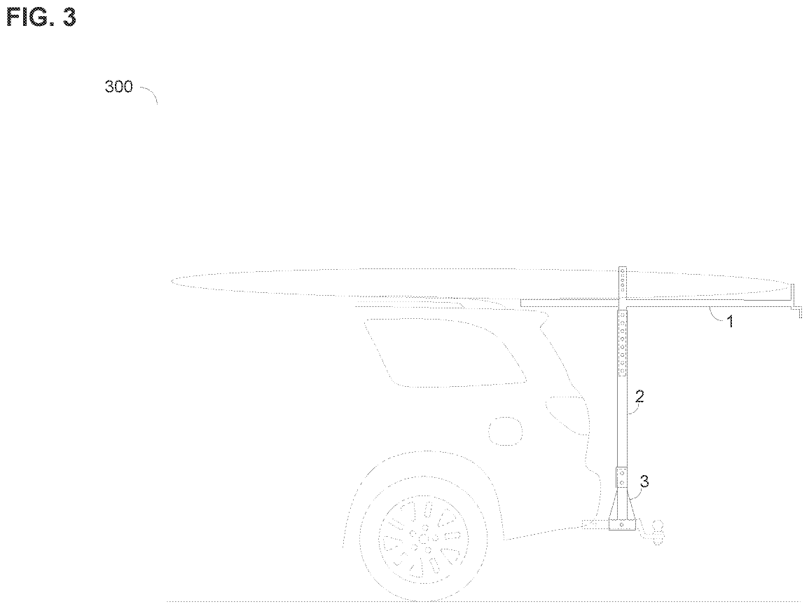

With reference to FIG. 3, the device 300 is stationed in the transport position and has been secured to a vehicle's hitch receiver by fastening the mounting channel 3 to a hitch receiver extension. From the loading and unloading position, the user lifts the upper rack assembly 1 carrying the load around the pivot point that connects the support arm 2 and the mounting channel 3 together. Once the load is resting on the vehicle's roof rack and the support arm 2 is in the vertical position, a pin can be inserted and fastened into the lower most hole locking the support arm 2 and mounting channel 3 in place.

From the transport position shown in FIG. 3, the load can be removed from the vehicle roof rack by moving the device 300 into the loading and unloading position as shown in FIG. 2. In order to lower the device 200 into the loading and unloading position, the lower most pin must be removed from the support arm 2 and the mounting channel 3 so as to unlock them from the vertical, transport position. Once the lower most pin has been removed, the upper rack assembly 1 carrying the load around can be pivoted down to rest on the ground around the upper most hole and pin that connects the support arm 2 and the mounting channel 3 together. At this point the load can be unfastened from the upper rack assembly 1 and removed from the device 200.

In this description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the principles of the invention. Additionally, certain steps may be performed concurrently in a parallel process when possible, as well as performed sequentially.

All publications, Internet sites, patents, and patent applications cited in this specification are herein incorporated by reference in their entirety as if each publication, patent, or patent application were specifically and individually put forth herein. Any Internet site contents and publications available on the Internet are incorporated herein as of the filing date of this patent application, even if such Internet sites or publications later become unavailable.

The embodiments, variations, and figures described above provide an indication of the utility and versatility of the present invention. Other embodiments that do not provide all of the features and advantages set forth herein may also be utilized, without departing from the spirit and scope of the present invention. Such modifications and variations are considered to be within the scope of the principles of the invention defined by the claims.

### REFERENCES

Zahn, James B., Paul B. Knight, and Larry D. Zahn. Multi-Functional, Hitch Mounted Carrying Apparatus. Hosco Incorporated, assignee. U.S. Pat. No. 5,775,560. 7 Jul. 1998. Print.
Spring, Joseph N., Jr. Equipment Transport Rack For Vehicles Providing Improved Loading Accessibility. U.S. Pat. No. 5,884,824. 23 Mar. 1999. Print.
Stiles, Christopher S. Kayak Handling System. U.S. Pat. No. 8,028,874. 4 Oct. 2011. Print.
Cropley, Richard O. Elongate Load Supporting Structure for a Vehicle. Rhino Rack Australia Pty Limited, assignee. Australian Patent Application AU 2012100198 A4. 24 Feb. 2012. Print.
Gray, Larry A. Watercraft Rack and Method of Racking the Same. U.S. Pat. No. 8,590,758. 26 Nov. 2013. Print.
Laverack, John, Greg G. Weaver, David Mathieu, and Joseph Paul. Kayak Transport Device for a Vehicle. Thule Sweden AB, assignee. U.S. Pat. No. 9,067,522. 30 Jun. 2015. Print.
Whiteford, Barry. Adjustable Support Structure for a Vehicle Cargo Bed Extension. U.S. Pat. No. 9,156,392. 13 Oct. 2015. Print.
VanAmburgh, Peter C. Hitch Mounted Rack system. U.S. Pat. No. 9,346,411. May 24, 2016. Print.

What is claimed is:

1. A hitch mounted carrying and roof rack loading device that can be configured between a loading and unloading position and a transport position, the device comprising:
an upper rack assembly, which may be adjustable in width, to which varying loads may be directly attached that is inserted into a support arm;
a support arm connected to a mounting channel, the connection comprising a removable pin which, when said pin is removed, allows said upper rack assembly and said support arm to pivot between a loading and unloading position at the ground level and a transport position adjustable in height to match the height of a vehicle's roof or other racks or other optimal height;
the mounting channel comprising a channel through which a hitch receiver extension can be inserted by which the device is attached to the vehicle;
and a hitch receiver extension that can be fastened to a vehicle's hitch receiver.

2. The hitch mounted carrying and roof rack loading device recited in claim 1, wherein the device can pivot at a point in its vertical member between 45 and 130 degrees.

3. The hitch mounted carrying and roof rack loading device recited in claim 1, wherein said upper rack assembly and support arm are locked into a vertical transport position when a pin is inserted through the support arm and mounting channel near the pivot point.

4. The hitch mounted carrying and roof rack loading device recited in claim 1, wherein said upper rack assembly and support arm are released from the locked, vertical transport position when a pin is removed from the support arm and mounting channel near the pivot point allowing said upper rack assembly and support arm to pivot to the ground into a loading and unloading position.

5. The hitch mounted carrying and roof rack loading device recited in claim 4, wherein the device provides access to the rear of a vehicle, including the ability to open a tailgate, rear window or rear door.

6. The hitch mounted carrying and roof rack loading device recited in claim 4, wherein the upper rack assembly may be additionally attached to the support arm by a spring or cylinder which reduces the effort required to transition the device from the loading and unloading position to the transport position.

7. The hitch mounted carrying and roof rack loading device recited in claim 4, wherein the device permits a load to be loaded or unloaded while standing on the ground before being positioned at a height above the vehicle's receiver, including up to the height of a vehicle's roof racks.

8. The hitch mounted carrying and roof rack loading device recited in claim 1, which attaches to a hitch receiver extension by a bracket, channel, or mechanism wider than the hitch receiver extension so as to not obstruct the primary receiver slot or function of the hitch receiver extension.

9. The hitch mounted carrying and roof rack loading device recited in claim 7, wherein such bracket, channel, or mechanism used to attach the device to the hitch receiver extension can accommodate receiver extensions of various sizes or dimensions.

10. The hitch mounted carrying and roof rack loading device recited in claim 7, wherein the hitch receiver extension permits an additional load to be attached to the vehicle by various means including other hitch mounted devices or hitches such as a ball to which a trailer can be attached.

11. The hitch mounted carrying and roof rack loading device recited in claim 7, wherein various lengths of hitch receiver extensions may be used to accommodate various load types, vehicle configurations or purposes.

12. The hitch mounted carrying and roof rack loading device recited in claim 7, wherein the hitch receiver extension is supported by additional members attaching outside the hitch receiver extension and also attaching to the vehicle's hitch receiver or frame.

13. A hitch mounted carrying and roof rack loading device recited in claim 1, where the device is adjustable in height to match various heights of vehicles or which may be positioned lower than the height of a vehicle.

14. The hitch mounted carrying and roof rack loading device recited in claim 1, which may be attached to a hitch receiver extension and a ball hitch or other mechanism used to tow a trailer, may be adjusted in height to allow loads or equipment to be transported in the airspace above the tongue of the trailer.

15. A hitch mounted carrying and roof rack loading device recited in claim 1 that may be comprised of lightweight materials for ease of use and mounting, which may be paired with a hitch receiver extension comprised of a different material strong enough to support the loads of a vehicle's full hauling capacity.

16. The hitch mounted carrying and roof rack loading device recited in claim 1, wherein the upper rack assembly is comprised of adjustable crossmembers that provide adequate support and mounting options to which loads or varying widths may be attached and secured independent from other attachments to the vehicle.

17. The hitch mounted carrying and roof rack loading device recited in claim 1, wherein the upper rack assembly includes attachment points or mechanisms to secure loads of varying depths independent from other attachments to the vehicle and which allow elongated loads to be secured in the loading and unloading position.

18. The hitch mounted carrying and roof rack loading device recited in claim 1, wherein the upper rack assembly may be supplemented by additional attachments to accommodate various loads or equipment.
